(19) United States
(12) Patent Application Publication
(10) Pub. No.: US 2024/0269888 A1
(43) Pub. Date: Aug. 15, 2024

(54) SYSTEM AND METHOD FOR MANUFACTURING MAT-FACED CEMENTITIOUS BOARD WITH IN-LINE BOND MEASUREMENT USING NON-CONTACT ULTRASOUND TRANSDUCERS

(71) Applicant: United States Gypsum Company, Chicago, IL (US)

(72) Inventor: Sooraj Kumar AMBADI OMANAKUTTAN NAIR, Evanston, IL (US)

(73) Assignee: United States Gypsum Company, Chicago, IL (US)

(21) Appl. No.: 18/419,213

(22) Filed: Jan. 22, 2024

Related U.S. Application Data
(60) Provisional application No. 63/484,736, filed on Feb. 13, 2023.

(51) Int. Cl. B28B 17/00; B28B 11/14; B28B 11/24; B28B 19/00; G01N 29/11; G01N 29/24

(52) U.S. Cl. CPC B28B 17/0072; B28B 11/14; B28B 11/243; B28B 19/0092; G01N 29/11; G01N 29/2481

(57) ABSTRACT

Embodiments of a system and a method for evaluating a mat-faced cementitious board specimen can be used to determine a bond strength value for the specimen. A moving assembly is configured to move a pair of non-contact ultrasonic transducers over an X-Y plane relative to the specimen supported in a support fixture such that the specimen is interposed between the transducers. A controller is configured to use ultrasonic signals from the transducers to determine the bond strength for at least one facer of a mat-faced cementitious board specimen. Transducer arrays can be outfitted downstream of the kiln, for example, to provide a system and a method for continuously measuring the bond strength of mat-faced cementitious board during the continuous manufacture thereof.

### CROSS-REFERENCE TO RELATED APPLICATION

This patent application claims the benefit of priority to U.S. Provisional Patent Application No. 63/484,736, filed Feb. 13, 2023, and entitled, “System and Method for Evaluating Mat-Faced Cementitious Board with Non-Contact Ultrasound Transducers,” which is incorporated in its entirety herein by this reference.

### BACKGROUND

The present disclosure relates to evaluating a mat-faced cementitious board specimen and, more particularly, to a system and method for evaluating a bond characteristic of a mat-faced cementitious board specimen.

Gypsum wallboard having a gypsum-based core reinforced on the outer major surfaces with a facing material or scrim (collectively referred to herein as being mat-faced) is well-known in the art. The facing material is often paper for typically dry environments, e.g., for indoor drywall products. For some applications, however, a glass or polymer-based mat is used in products that may be exposed to high moisture conditions. For example, such board is useful in exterior sheathing products. Glass-mat gypsum board sheathing can be applied to outer studs, joists, or rafters of a home or commercial building to strengthen the structure and provide fire resistance and a degree of water resistance. The sheathing provides a base for exterior cladding (e.g., bricks, siding, stone, etc.) to be applied, with an additional moisture and vapor barrier substrate optionally applied therebetween.

Glass-mat gypsum board can also be utilized in indoor applications where the board may be exposed to significant moisture. For example, glass-mat faced board can be used in a variety of indoor locations, such as in sink or tub enclosures, backsplashes, etc. The glass-mat faced board provides a base for ceramic tile or the like to be applied, e.g., using mortar or mastic to secure the tile to the base. The glass mat provides a degree of water resistance and mold resistance over time in case water penetrates through the set mortar or mastic, e.g. through cracks in the tile or grout.

The manufacturing process of mat-faced gypsum board typically involves depositing cementitious slurry (e.g., a mixture containing stucco and water, where stucco refers to calcined gypsum, typically comprised primarily of calcium sulfate hemihydrate and/or calcium sulfate anhydrite) over a first mat facing material and covering the wet slurry with a second mat facing material, usually of the same type, such that the cementitious slurry is sandwiched between the two mat facing materials. The cementitious slurry is allowed to harden (e.g., forming an interlocking matrix of calcium sulfate dihydrate, referred to as set gypsum) and subjected to drying in a kiln to remove excess water not consumed in the hydration process to produce a solid article.

The manufacturing process of mat-faced gypsum board, thus, often requires the facing material to be sufficiently permeable that excess water can be removed from the cementitious slurry in the drying process. For example, non-woven fiberglass mat is often used as the facing material, in which the space between the fibers provides permeability. The permeability of the fibrous mat facing material, if not treated, could reduce the water-resistance of the cementitious article because it allows water to penetrate the mat and contact the cementitious core during use. In order to alleviate this problem, exterior coatings of water resistant material can be applied.

The strength of the bond between the mats and the cementitious core is commonly used to evaluate the quality of the mat-faced cementitious board. Bond strength is conventionally measured by conducting a destructive test in which the mat is pulled away in a normal Z-direction (perpendicular to the plane of the mat) from the core, and the amount of force required to separate the mat is measured. Although this measurement technique is reliable and effective, it destroys the specimen.

There is a continued need in the art to provide additional solutions to enhance the production of cementitious boards. For example, there is a continued need for techniques for evaluating the bond strength of mat-faced cementitious board.

It will be appreciated that this background description has been created to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### SUMMARY

In one aspect, the present disclosure is directed to embodiments of a system for evaluating a mat-faced cementitious board specimen. In embodiments, the evaluation system includes at least one non-contact (air-coupled) ultrasound transmitter transducer and at least one non-contact ultrasound receiver transducer.

In another aspect, the present disclosure describes embodiments of a method for evaluating a mat-faced cementitious board specimen. In embodiments, the evaluation method includes using a system for evaluating a mat-faced cementitious board specimen constructed in accordance with principles of the present disclosure to evaluate the bond strength of the mat-faced cementitious board specimen. In embodiments, the evaluation method includes using a non-contact ultrasound transmitter transducer and a non-contact ultrasound receiver transducer to measure bond strength of the mat-faced cementitious board specimen.

In yet another aspect, the present disclosure describes embodiments of a system for manufacturing a mat-faced cementitious board. In embodiments, the manufacturing system includes a non-contact ultrasound transmitter transducer array and a non-contact ultrasound receiver transducer array disposed next to a downstream end of a conveyor section extending along a machine direction. The transducer arrays extend along a transverse axis of the conveyor section, which is perpendicular to the machine direction. The transducer arrays are disposed in spaced relationship to each other along a normal axis, which is perpendicular to both the machine direction and the transverse axis, such that a mat-faced cementitious board can pass along the machine direction between the transducer arrays.

In one embodiment, a system for manufacturing a mat-faced cementitious board includes a kiln, a conveyor, and a board bond measuring system. The mat-faced cementitious board has a mat bonded to a cementitious core, and the cementitious core is formed from an aqueous cementitious slurry.

The kiln is configured to remove excess water from the aqueous cementitious slurry. The conveyor is configured to convey the cementitious board along a machine direction away from the kiln. The conveyor includes an upstream support surface and a downstream support surface which both extend along the machine direction and a transverse axis, which is perpendicular to the machine direction. The upstream support surface and the downstream support surface are in discontinuous relationship with respect to each other such that an unsupported span is defined therebetween.

The board bond measuring system includes a non-contact ultrasound transmitter transducer array, a non-contact ultrasound receiver transducer array, a non-transitory computer-readable medium, and a controller. The non-contact ultrasound transmitter transducer array and the non-contact ultrasound receiver transducer array are disposed in the unsupported span such that the transducer arrays extend along the transverse axis. The transducer arrays are disposed in spaced relationship to each other along a normal axis, which is perpendicular to both the machine direction and the transverse axis, such that the mat-faced cementitious board is adapted to move along the machine direction from the upstream support surface to the downstream support surface and pass between the transducer arrays along the normal axis. The ultrasound receiver transducer array is configured to transmit an ultrasound reception signal therefrom. The ultrasound reception signal is indicative of the strength of an ultrasound signal received by the ultrasound receiver transducer array from the ultrasound transmitter transducer array.

The non-transitory computer-readable medium bears a board bond measurement program. The controller is in operable arrangement with the ultrasound receiver transducer array to receive the ultrasound reception signal therefrom. The controller is in operable arrangement with the non-transitory computer-readable medium such that the controller is configured to execute the board bond measurement program contained thereon. The board bond measurement program includes a bond strength module configured to determine a numerical bond strength value for the mat-faced cementitious board based upon the ultrasound reception signal.

In still another aspect of the present disclosure, embodiments of a method of manufacturing a mat-faced cementitious board are described. In embodiments, the manufacturing method includes passing the mat-faced cementitious board along a machine direction between a non-contact ultrasound transmitter transducer array and a non-contact ultrasound receiver array disposed next to a downstream end of a conveyor section extending along the machine direction. The transducer arrays extend along a transverse axis of the conveyor section, which is perpendicular to the machine direction. The transducer arrays are disposed in spaced relationship to each other along a normal axis, which is perpendicular to both the machine direction and the transverse axis.

In one embodiment, a method of manufacturing a mat-faced cementitious board includes applying a mat to a cementitious core, which is formed from an aqueous cementitious slurry. The mat-faced cementitious board is dried in a kiln to remove excess water from the aqueous cementitious slurry. The mat-faced cementitious board is conveyed along a machine direction away from the kiln. The mat-faced cementitious board extends along the machine direction and along a transverse axis, which is perpendicular to the machine direction.

The mat-faced cementitious board is passed along the machine direction past a non-contact ultrasound transmitter transducer array and a non-contact ultrasound receiver transducer array. The transducer arrays extend along the transverse axis and are in spaced relationship to each other along a normal axis, which is perpendicular to the machine direction and to the transverse axis, such that the mat-faced cementitious board passes between the transducer arrays along the normal axis. An ultrasound signal is emitted from the ultrasound transmitter transducer array such that the ultrasound signal passes through the mat-faced cementitious board and is received by the ultrasound receiver transducer array. The ultrasound receiver transducer array transmits an ultrasound reception signal to a controller. The ultrasound reception signal is indicative of the strength of the ultrasound signal received by the ultrasound receiver transducer array from the ultrasound transmitter transducer array. A board bond measurement program stored upon a non-transitory computer-readable medium is executed using the controller to generate a numerical bond strength value for the mat-faced cementitious board based upon the ultrasound reception signal.

Further and alternative aspects and features of the disclosed principles will be appreciated from the following detailed description and the accompanying drawings. As will be appreciated, the systems and techniques for evaluating a mat-faced cementitious board specimen and for manufacturing a mat-faced cementitious board disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is perspective elevational view of an embodiment of a system for evaluating a mat-faced cementitious board specimen constructed in accordance with principles of the present disclosure, illustrating a mat-faced cementitious board specimen mounted in the system.

FIG. 2 is another perspective elevational view of the evaluation system of FIG. 1, including an enlarged detail view of a non-contact ultrasound transmitter transducer and a non-contact ultrasound receiver transducer of the evaluation system with the mat-faced cementitious board specimen disposed therebetween along an axis perpendicular to the plane defined by the board specimen.

FIG. 3 is a schematic representation of a non-contact ultrasound transmitter transducer and a non-contact ultrasound receiver transducer of an embodiment of a system for evaluating a mat-faced cementitious board specimen constructed in accordance with principles of the present disclosure with a mat-faced cementitious board specimen disposed therebetween along an axis perpendicular to the plane defined by the board specimen.

FIG. 4 is a fragmentary, schematic view of an embodiment of a system for manufacturing a mat-faced cementitious board constructed in accordance with principles of the present disclosure, illustrating a mat-faced cementitious board being transported past, in machine direction, a non-contact ultrasound transmitter transducer array and a non-contact ultrasound receiver transducer array such that the board passes between, along an axis perpendicular to the plane defined by the board, the transducer arrays.

FIG. 5 is a schematic top plan view of an exemplary transducer array suitable for use in a system for manufacturing a mat-faced cementitious board constructed in accordance with principles of the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF EXEMPLARY EMBODIMENTS

The present disclosure provides various embodiments of a system and a method for evaluating a mat-faced cementitious board specimen to measure its bond strength. Embodiments of a system and a method for evaluating a mat-faced cementitious board specimen following principles of the present disclosure include at least one air-coupled ultrasonic transducer which can be used to effectively determine the bond strength of the mat-faced cementitious board using a non-destructive, non-contact ultrasonic technique.

Embodiments of a system and a method for evaluating a mat-faced gypsum board specimen following principles of the present disclosure can use an air-coupled ultrasonic pulse velocity technique to find the attenuated signal strength through the specimen and correlate it to the bond strength between a mat facer (e.g., a glass mat facer) and the cementitious core (e.g., gypsum core) of the specimen. In embodiments, the attenuated signal strength data is correlated to bond strength. This quantitative measuring technique provides a non-destructive approach to evaluating bond strength of the mat-faced cementitious board. In embodiments, air-coupled ultrasonic evaluation using embodiments of a system and a method for evaluating a board specimen following principles of the present disclosure can be used as a non-destructive bond strength qualification method for glass-mat gypsum boards.

Embodiments of a system and a method for evaluating a mat-faced gypsum board specimen to measure bond strength following principles of the present disclosure includes utilizing an air-coupled ultrasonic technique to predict the bond strength. In embodiments, a bond strength for a mat-faced cementitious board specimen can be determined using the attenuated signal strength data and a database of mat-faced cementitious board specimen data which includes attenuated signal strength data and destructive Z-bond pull data for each such specimen. In embodiments, the measured attenuated signal strength for a given sample can be compared to the database to extrapolate a Z-bond pull value for the specimen without conducting such destructive testing.

In embodiments, the air-coupled ultrasound transducers traverse over a predetermined area of the mat-faced cementitious board specimen, sending an ultrasound signal from the transmitter transducer through the specimen to the receiver transducer. A controller is programmed to determine the signal loss (or attenuation) from the parent signal based upon the received signal at the receiver transducer. In embodiments, the controller is programmed to determine regions of the specimen with “good,” sufficiently strong, and “poor,” unacceptably weak, bond based upon predetermined values of signal loss, and the specimen can be qualified or rejected based on predetermined criteria for signal loss.

In another aspect of the present disclosure, the present disclosure describes embodiments of a system for manufacturing a mat-faced cementitious board. The present disclosure provides various embodiments of a system for continuously measuring the bond of mat-faced cementitious board during the continuous manufacture thereof that can be used in connection with the manufacture of various mat-faced cementitious products, including glass-mat gypsum board, for example. Embodiments of a system for measuring mat-faced cementitious board during its continuous manufacture following principles of the present disclosure can be used online in a continuous manufacturing process to effectively determine the degree to which one or both of the mat facers has bonded to the cementitious core (e.g., expressed as a function of attenuated ultrasonic signal strength) at a predetermined location, such as, downstream of a kiln, for example, without contacting the mat-faced cementitious board as it moves along the board line. In embodiments, the system can be configured to issue an operator alert when a target attenuated ultrasonic signal strength profile is not satisfied.

In embodiments, the manufacturing system includes a non-contact ultrasound transmitter transducer array and a non-contact ultrasound receiver array disposed next to a downstream end of a conveyor section extending along a machine direction. The transducer arrays extend along a transverse axis of the conveyor section, which is perpendicular to the machine direction. The transducer arrays are disposed in spaced relationship to each other along a normal Z-axis, which is perpendicular to both the machine direction and the transverse axis, such that a mat-faced cementitious board, moving in the machine direction, passes between the transducer arrays along the normal axis.

In another aspect, the present disclosure describes embodiments of a method of manufacturing a mat-faced cementitious board. In embodiments, the manufacturing method includes passing the mat-faced cementitious board along a machine direction between a non-contact ultrasound transmitter transducer array and a non-contact ultrasound receiver array disposed next to a downstream end of a conveyor section extending along the machine direction. The transducer arrays extend along a transverse axis of the conveyor section, which is perpendicular to the machine direction. The transducer arrays are disposed in spaced relationship to each other along a normal Z-axis, which is perpendicular to both the machine direction and the transverse axis, such that the mat-faced cementitious board passes between the transducer arrays along the normal axis.

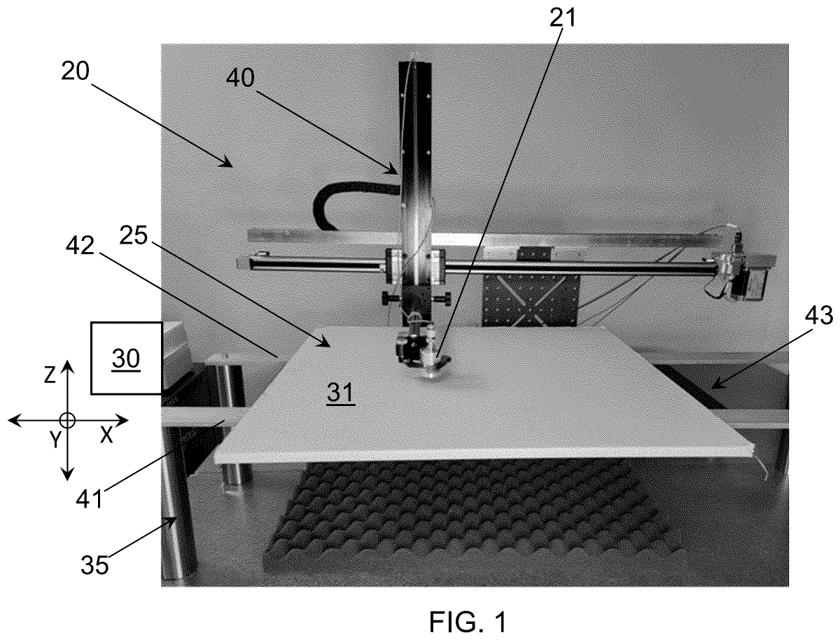

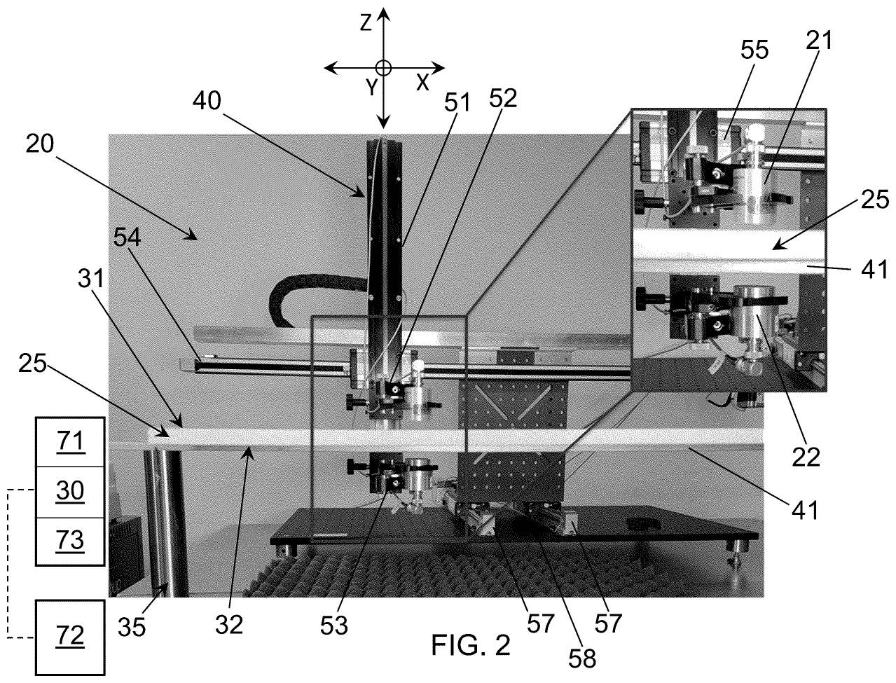

Turning now to the Figures, an embodiment of a system 20 for evaluating a mat-faced cementitious board specimen constructed according to principles of the present disclosure is shown in FIGS. 1 and 2. Referring to FIGS. 1 and 2, the evaluation system 20 is configured to move axially-aligned air-coupled ultrasonic transducers 21, 22 over a predetermined field in a plane defined by an X-axis and a perpendicular Y-axis along which a mat-faced cementitious board specimen 25 is disposed. In embodiments, the ultrasonic transducers 21, 22 include at least one non-contact ultrasound transmitter transducer 21 and at least one non-contact ultrasound receiver transducer 22 with the mat-faced cementitious board 25 disposed therebetween along a normal Z-axis, which is perpendicular to both the X-axis and the Y-axis, such that the transmitter transducer 21 can emit an ultrasound signal along the Z-axis that passes through the board specimen 25 and is received by the receiver transducer 22.

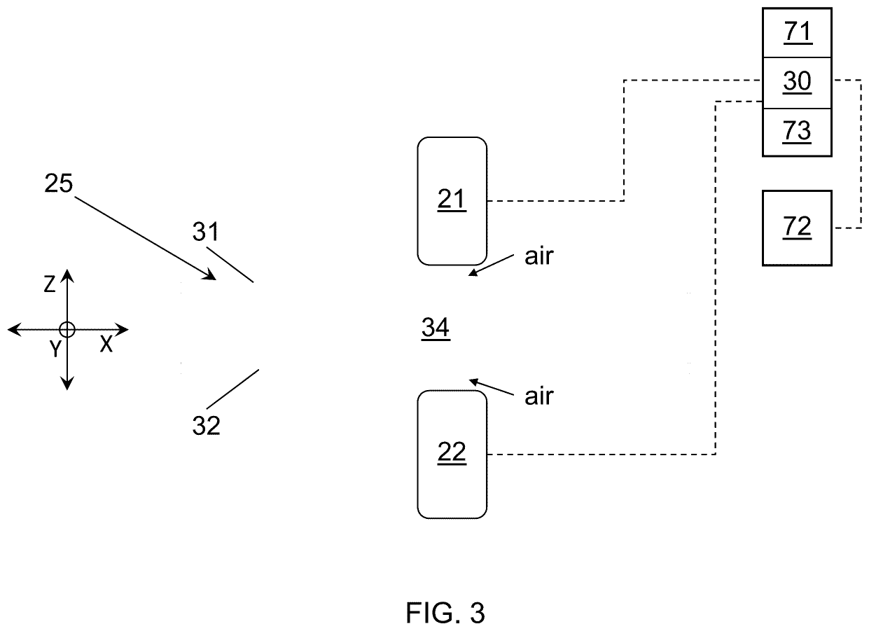

In embodiments, the evaluation system 20 includes a controller 30 in operable communication with the axially-paired transducers 21, 22 and configured to capture ultrasound measurements using the axially-paired transducers 21, 22 as they move over the predetermined field in the X-Y plane. In embodiments, the controller 30 is configured to measure the attenuated signal strength, the difference between the ultrasound signal emitted by the transmitter transducer 21 and the ultrasound signal received by the receiver transducer 22, as the axially-paired transducers 21, 22 move over the predetermined field in the X-Y plane. In embodiments, the controller 30 is configured to determine the average signal strength over the predetermined field in the X-Y plane. In embodiments, the controller 30 of the evaluation system 20 is configured to use the ultrasound measurements over the predetermined field in the X-Y plane to determine a bond strength value for the mat-faced cementitious board specimen 25 that is correlated to the bond strength of at least one mat 31, 32 and a cementitious core 34 of the mat-faced cementitious board specimen 25 (see FIG. 3). In embodiments.

In embodiments, the system 20 can include air-coupled ultrasonic transducers 21, 22 used to predict the bond strength of glass mat gypsum boards 25. The glass mat-gypsum core bond can be identified to be relatively stronger or weaker from the attenuated signal strength map acquired using this non-contact technique. For example, in embodiments using a transducer in a range from 100 kHz to 500 kHz, a value in a range between −28 dB to −30 dB can be used as a demarcation between a weak face mat bond and a sufficiently strong bond.

In embodiments, the evaluation system 20 can be configured for use with a mat-faced cementitious board specimen 25 of any suitable size and/or shape. For example, in embodiments, the specimen 25 can have a rectangular shape, such as a nominal one foot by two foot rectangle. In embodiments, the mat-faced cementitious board specimen 25 can be square-shaped, such as a nominal six inch by six inch square. In embodiments, the mat-faced cementitious board specimen 25 has a nominal four foot transverse width and a suitable length, such as a length in a range between two feet and four feet, for example. In embodiments, the specimen 25 can include edges along its length that are tapered. In embodiments, the specimen 25 can have at least one mat facer 31, 32 that is substantially planar.

In the illustrated embodiment, the evaluation system 20 includes a support fixture 35, a moving assembly 40, the non-contact ultrasound transmitter transducer 21, the non-contact ultrasound receiver transducer 22, and the controller 30. The support fixture 35 is configured to support the mat-faced cementitious board specimen 25 so that the ultrasound transducers 21, 22 can be positioned above and below the specimen 25 in aligned relationship with each other along the Z-axis for evaluating the specimen 25. The ultrasound transducers 21, 22 can be mounted to the moving assembly 40 such that the mat-faced cementitious board specimen 25 can be supported by the support fixture 35 and the board 25 is disposed, along the normal Z-axis, between the ultrasound transducers 21, 22. The moving assembly 40 is configured to move the axially-aligned air-coupled ultrasonic transducers 21, 22 over a predetermined field in a plane defined by the X-axis and the perpendicular Y-axis along which the mat-faced cementitious board specimen 25 is supported in the support fixture 35.

Referring to FIG. 1, in embodiments, the support fixture 35 includes supports 41, 43 that permit the specimen 25 to be supported while providing an opening below the specimen 25 in which one of the transducers 22 can be disposed below the specimen 25 in the opening so that there is only air between this transducer and the specimen (see FIG. 2). The illustrated support fixture includes a first platform 41 and a second platform 42 that are in spaced relationship to each other along the Y-axis to define an opening 43 therebetween. The platforms 41, 42 are configured to support the specimen 25 such that a central area of the specimen is unsupported and accessible from underneath the specimen 25 via the opening 43. In other embodiments, the support fixture 35 can have a different arrangement, as will be appreciated by one skilled in the art. For example, in embodiments, the support fixture 35 can include a single table with a support surface that has a central opening that is at least as big as the desired X-Y field of analysis for the specimen 25.

Referring to FIG. 2, the illustrated moving assembly 40 comprises a three-axis (x-y-z) positioning stage which is controlled by the controller 30. In embodiments, the moving assembly 40 includes a Z-rail 51 extending along the Z-axis and to which a first transducer arm 52 and a second transducer arm 53 are mounted. The first and second transducer arms 52, 53 extend along the Y-axis and respectively support the transmitter transducer 21 and the receiver transducer 22 in a first X-Y plane and a second X-Y plane such that the transducers 21, 22 are axially-aligned along the Z axis and the specimen 25 is disposed therebetween along the Z-axis. The support fixture 35 is provided for supporting the specimen 25 along the Z-axis between the first and second X-Y planes.

In embodiments, the first and second transducer arms 52, 53 are independently movable along the Z-rail 51 to change the respective positions of the transducers 21, 22 along the Z-axis. In embodiments, the transducer arms 52, 53 are extendable along the Y-axis to selectively move the transducers 21, 22, respectively, along the Y-axis relative to at least one of the board specimen 25 and the Z-rail 51.

The moving assembly 40 includes an X-rail 54 with a carriage 55 to which the Z-rail 51 is mounted. The carriage 55 is movable along the X-rail 54 to selectively move the transducers 21, 22 along the X-axis relative to the board specimen 25.

The moving assembly 40 includes a pair of Y-rails 57 with a mounting plate 58 connected therebetween to which the X-rail 54 is mounted. The mounting plate 58 is movable along the Y-rails 57 to selectively move the transducers 21, 22 along the Y-axis relative to the board specimen 25.

In embodiments, the moving assembly 40 can include any suitable drive mechanism and motor. In embodiments, the moving assembly 40 includes one or more suitable motors and drive mechanism, such as, e.g., a suitable servo motor and an endless belt, to selectively reciprocally move the transducers 21, 22 along the X-axis and the Y-axis, and, in at least some embodiments, along the Z-axis. In embodiments, each motor of the moving assembly 40 is in electrical communication with the controller 30 such that the controller 30 can be used to control the movement of the transducers 21, 22 via the moving assembly 40. In embodiments, the controller 30 can be programmed such that the moving assembly 40 moves the transducers 21, 22 over at least one predetermined measuring path.

In embodiments, the moving assembly 40 can have a drive mechanism with a different form, such as a screw or a rack and pinion arrangement, for example. In embodiments, any suitable motor can be used.

The controller 30 is in communication with the transducers 21, 22 to receive a respective ultrasonic signal therefrom. In embodiments, the controller can be in operable communication with the transducers 21, 22 via any suitable technique, such as, by being hard-wired thereto, for example. In other arrangements a wireless connection technique or any suitable connection technique can be used as will be understood by one skilled in the art. In embodiments, the controller 30 is programmed to determine a bond strength value for the mat-faced cementitious board specimen 25 using the ultrasonic measurement data generated by the transducers 21, 22.

In embodiments, the controller 30 is programmed with a mat-faced cementitious board analyzing application, comprising a board bond measurement program, that is stored on a non-transitory computer readable medium 71. The mat-faced cementitious board analyzing application is configured to operate the system 20 and use the ultrasonic signals from at least one non-contact ultrasonic transducer 21, 22 to determine a bond strength value for the mat-faced cementitious board specimen 25.

In embodiments, the controller 30 is configured to control the moving assembly 40 to selectively move the transducers 21, 22 in the X-Y plane over the analysis field. In embodiments, the controller 30 is configured to move the carriage 55 along the X-rail 54 to move the transducers 21, 22 along the X-axis, and is configured to move the transducer arms 52, 53 in tandem along the Y-axis by moving the plate 58 along the Y-rails 57 to move the transducers 21, 22 along the Y-axis to cover the field of analysis.

In embodiments, the controller 30 is configured to adjust the distance between the first and second transducer arms 52, 53 to bring the transducers 21 22 within a desired distance of the mat facers 31, 32 of the specimen 25 (see also FIG. 3). In embodiments, the controller 30 is in operable relationship with a vision system to facilitate the automatic placement of the transducer arms 52, 53 with respect to a given board specimen 25 supported on the support fixture 35.

In embodiments, the controller 30 is in operable communication with the ultrasound sending transducer 21 and the ultrasound receiving transducer 22 to operate the transducers 21, 22 and to receive ultrasonic data therefrom. In embodiments, the controller 30 is programmed for gathering data from the ultrasound transducers 21, 22 for evaluating the bond strength of the specimen 25 and for displaying the results in a display device 72. In embodiments, the controller 30 is programmed to cause an ultrasound pulse to pass from the ultrasound transmitter 21 through the board specimen to the ultrasound receiver 22 and conduct ultrasonic analysis of the board specimen 25 based upon the ultrasonic signals received by the controller 30 from the transducers 21, 22.

The controller 30 may be provided with an internally-integrated transmitter transducer excitation mechanism or have an external transmitter transducer excitation mechanism with which it is in operable arrangement. In embodiments, the excitation mechanism may be any suitable one that is compatible with the transducers 21, 22 of the system 20, such as, e.g., a pulser. The controller 30 may be provided with an internally-integrated receiving transducer amplification mechanism or have an external receiving transducer amplification mechanism with which it is in operable arrangement. In embodiments, the receiving transducer amplification mechanism may be any suitable one that is compatible with the transducers 21, 22 of the system 20, such as, e.g., a receiver amplifier. The controller 30 may also include or be in operable arrangement with an analog-to-digital converter and a logic unit with software programmed into the controller 30. The controller 30 may be any suitable controller such as, e.g., a programmed microcontroller which includes a CPU. The controller 30 is in communication with the components of the system 20 using any suitable technique, such as by being hard-wired with leads, for example.

The controller 30 can be in communication with the moving assembly 40 and the transducers 21, 22. In embodiments, the controller 30 is programmed with a mat-faced cementitious board analyzing application stored on a non-transitory computer readable medium 71. In embodiments, the mat-faced cementitious board analyzing application can be used to program the controller 30 to operate the evaluation system 20 and to conduct various board specimen analyzing protocols.

In embodiments, the mat-faced cementitious board analyzing application can include a control module configured to control the operation of the evaluation system 20. For example, in embodiments, the controller 30 can be programmed to control the moving assembly 40 to direct the transducers 21, 22 over a predetermined measurement path.

In embodiments, the mat-faced cementitious board analyzing application can include a bond strength module configured to determine a numerical bond strength value for a mat-faced cementitious board specimen 25 based upon an ultrasonic measuring protocol. In embodiments, the controller 30 is in communication with the transducers 21, 22 to receive the ultrasonic signals therefrom. In embodiments, the mat-faced cementitious board analyzing application is configured to use the ultrasonic signals received from the transducers 21, 22, which is indicative of the signal strength attenuation measured over the travel of the transducers, to determine a bond strength value for the mat-faced cementitious board specimen 25.

In embodiments, the controller 30 includes a data storage device 73 configured to store mat-faced cementitious board specimen data for use by the analyzing application and/or generated by the analyzing application. In embodiments, the controller 30 can be in operable relationship with a database in the data storage device 73 which contains ultrasonic data generated from the evaluation system 20 for a statistically significant number of specimens 25 and destructive Z-bond separation pull testing of those specimens 25 following a predetermined destructive testing protocol in which both results are correlated quantitatively. In embodiments, the quantitative estimation is performed using i) average signal strength in the Z-bond test area and ii) attenuation in which the signal strength is a function of the interfacial bond strength between the mats 31, 32 and the cementitious core 34. In embodiments, the dataset is normalized. In embodiments, the mat-faced cementitious board analyzing application is configured to use the database to determine Z-bond separation pull force for a given specimen 25 based upon the ultrasonic data generated by the evaluation system 20 for the specimen 25.

In embodiments, the controller 30 can comprise any suitable computing device, such as, a microprocessor, a mainframe computer, a digital signal processor, a portable computing device, a personal organizer, a device controller, or a computational engine within an appliance. In embodiments, the controller 30 can comprise a collection of computing devices. In embodiments, the controller 30 includes one or more input devices (e.g., a keyboard and a mouse) and a display device (e.g., a monitor).

In embodiments, the mat-faced cementitious board analyzing application can be stored upon any suitable computer-readable storage medium 71. For example, in embodiments, a mat-faced cementitious board analyzing application following principles of the present disclosure can be stored upon a hard drive, floppy disk, CD-ROM drive, tape drive, zip drive, flash drive, optical storage device, magnetic storage device, and the like.

In embodiments, the mat-faced cementitious board analyzing application includes a graphical user interface that can be displayed by the display device 72. The graphical user interface can be used to facilitate the inputting of commands and data by a user to the mat-faced cementitious board analyzing application and to display outputs generated by the mat-faced cementitious board analyzing application.

In embodiments, the evaluation system 20 can include other components and equipment, as will be appreciated by one skilled in the art. For example, in embodiments, the evaluation system 20 can include at least one laser sensor operably arranged with the controller 30 to help facilitate the automatic positioning of the transducers 21, 22 along the normal Z-axis with respect to the specimen 25 such that each transducer 21, 22 is disposed a predetermined distance away from the specimen 25 along the normal Z-axis. In embodiments, the evaluation system 20 can include a commercially-available ultrasonic test unit, such as one commercially available from The Ultran Group of State College, Pennsylvania.

In embodiments, a mat-faced cementitious board analyzing application following principles of the present disclosure can be configured to implement an embodiment of a mat-faced cementitious board testing protocol according to principles of the present disclosure. In embodiments, the mat-faced cementitious board analyzing application can include other modules and features that are configured to carry out one or more features of an embodiment of a method of evaluating a mat-faced cementitious board specimen following principles of the present disclosure, as will be appreciated by one skilled in the art.

Embodiments of a method of evaluating a mat-faced cementitious board specimen can be carried out using a system of evaluating a mat-faced cementitious board specimen following principles of the present disclosure. In embodiments, the mat-faced cementitious board specimen 25 is supported by the support fixture 35 between the first and second X-Y planes established by the transducer arms 51, 52. The x-y positioning stage 40 is controlled by the controller 30 to move the transducers 21, 22 in tandem to generate a two-dimensional ultrasonic profile of the specimen 25 based upon at least one ultrasonic signal from the transducers 21, 22.

By analyzing the ultrasonic data from the transducers 21, 22 generated using a standardized measuring path upon one mat-faced cementitious board specimen 25 and comparing the ultrasonic data from other mat-faced cementitious board specimens using the same experimental parameters and, in at least some embodiments, the destructive Z-bond separation pull testing of those specimens following a predetermined destructive testing protocol, the bond strength of the mat-faced cementitious board specimen can be quantitatively measured and compared to other mat-faced cementitious board specimens for use in a quality control process.

Referring to FIG. 3, a schematic representation is shown of a non-contact ultrasound transmitter transducer 21 and a non-contact ultrasound receiver transducer 22 which are suitable for use in embodiments of a system for evaluating a mat-faced cementitious board specimen constructed in accordance with principles of the present disclosure. A mat-faced cementitious board specimen 25 is disposed between the transducers along the Z-axis. The coupling medium for ultrasound transmission in the specimen is a gas, such as air, either under ambient or under a high pressure environment.

In embodiments, the evaluation system 20 can include any suitable ultrasonic transducer. For example, in embodiments, the evaluation system 20 can include any suitable non-contact (air coupled) ultrasonic transducer so that the system 20 can be used to evaluate bond strength in a manner that is free from any contact with the mat-faced cementitious board specimen 25 as is shown in FIG. 3. In embodiments, the non-contact ultrasonic transducers 21, 22 can be similar to those described in U.S. Pat. No. 6,311,573, entitled “Ultrasonic Transducer for High Transduction in Gases and Method for Non-contact Transmission in Solids,” incorporated herein by reference in its entirety.

In embodiments of the evaluation system 20, a second ultrasonic sensor 22 is used when operating the system 20 in the transmission mode. This receiving transducer 22 is capable of receiving the pulsed signal from the transmitting transducer 21 through air alone as well as through the specimen 25 and air. The received signal is fed into a receiver which can be internally mounted within the controller 30, or as a separate receiver amplifier. In embodiments, the received signal is processed using an analog-to-digital converter and is then fed into the logic unit of the controller 30. The received signal strength relative to the transmitted signal strength emitted by the transmitting transducer 21 can be compared by the controller 30 to determine the attenuated signal strength for use in determining the bond strength of the specimen 25.

In embodiments, the evaluation system 20 can include a non-contact ultrasonic transducer configured to operate in pulse-echo mode. In at least some of such embodiments, the controller 30 can be programmed to cause the transmitting ultrasound sensor 21 to operate in the pulse echo mode.

In embodiments, a system for manufacturing a mat-faced cementitious board constructed according to principles of the present disclosure includes a kiln, first and second conveyor sections, and an evaluation system which has transducer arrays positioned so that the transducer arrays run along the width of the board and the board extends between the transducer arrays and a controller programmed with a mat-faced cementitious board analyzing application. The mat-faced cementitious board has a cementitious core interposed between a pair of mat-facers. The cementitious core is formed from an aqueous cementitious slurry.

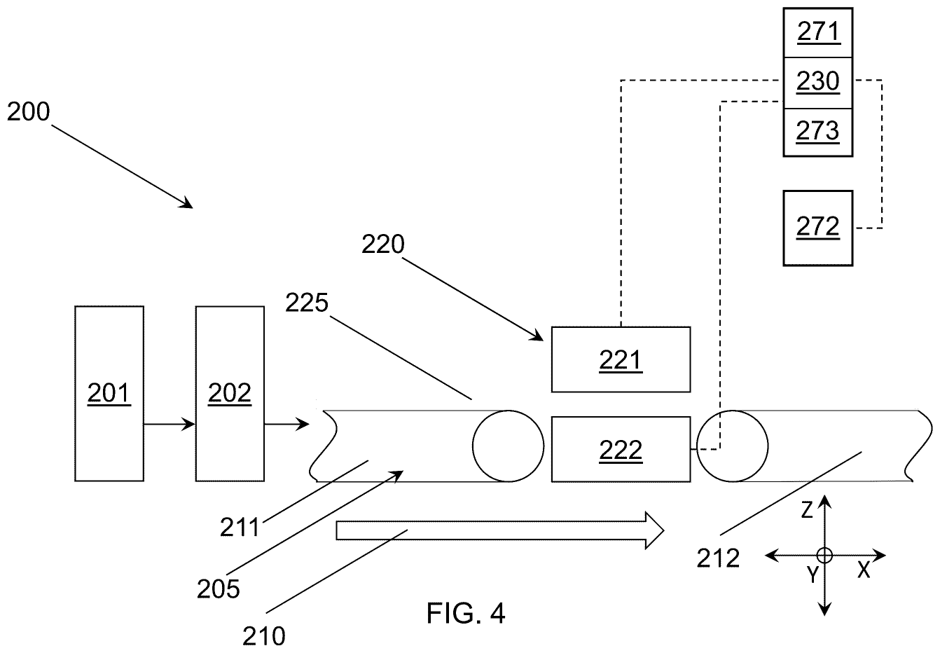

Referring to FIG. 4, a fragmentary, schematic view of a system 200 for manufacturing a mat-faced cementitious board 225 constructed in accordance with principles of the present disclosure is shown. The system 200 for manufacturing a mat-faced cementitious board 225 includes a cutting station 201, a kiln 202, a conveyor 205, and a board bond measuring system 220. The mat-faced cementitious board 225 has a pair of mats 31, 32 bonded to a cementitious core 34 such that the cementitious core 34 is interposed between the pair of mats 31, 32, as is shown in FIG. 3. The cementitious core 34 is formed from an aqueous cementitious slurry.

Referring to FIG. 4, the mat-faced cementitious board 225 extends along a machine direction 210 of the system 200, which extends along a longitudinal X-axis, and a transverse Y-axis, which is perpendicular to the machine direction 210. In embodiments, the cutting station 201 is disposed upstream of the kiln 202 along the machine direction 210. The cutting station 201 includes a knife configured to periodically cut the mat-faced cementitious board 225 along a cross-machine direction, the transverse Y-axis, to define a series of board segments as the mat-faced cementitious board 225 moves along the machine direction 210 past the cutting station 201. In embodiments, any suitable known cutter configuration can be used, such as a rotary-style knife, for example. In embodiments, the cutting station 201 is disposed downstream, along the machine direction 210, a suitable distance from a forming station, based upon line speed, to permit the aqueous cementitious slurry to hydrate and set. The forming station can be disposed downstream, along the machine direction 210, from a suitable wet end at which the aqueous cementitious slurry is formed and the mat or mats are applied.

In embodiments, the kiln 202 is disposed downstream of the cutting station 201 along the machine direction 210. The kiln 202 is configured to remove excess water from the aqueous cementitious slurry. In embodiments, an additional cutting station can be provided downstream of the kiln 202 at which the board segment is further cut into shorter length boards. In embodiments, any suitable, commercially-available kiln can be used, as will be appreciated by one skilled in the art.

The conveyor 205 is configured to convey the mat-faced cementitious board 225 along the machine direction 210 away from the kiln 202. The conveyor 205 includes conveyor sections 211, 212 that define an upstream support surface and a downstream support surface, respectively. The upstream support surface 211 and the downstream support surface 212 both extend along the machine direction 210 and the transverse Y-axis. The upstream support surface 211 and the downstream support surface 212 are in discontinuous relationship with respect to each other such that an unsupported span is defined therebetween along the machine direction 210 within which the transducer arrays 221, 222 are disposed such that the cementitious board is allowed to pass therebetween along a normal Z-axis, which is perpendicular to both the machine direction 210 and the transverse axis 230. In embodiments, the transducer arrays 221, 222 can be disposed downstream of the kiln along the machine direction 210.

The mat-faced cementitious board 225 is supported upon the first conveyor section 211 and the second conveyor section 212 downstream from the first conveyor section 211 such that the board 225 can be transported past the system 220 for evaluating the mat-faced cementitious board 225 that includes a non-contact ultrasound transmitter transducer array 221 and a non-contact ultrasound receiver transducer array 222.

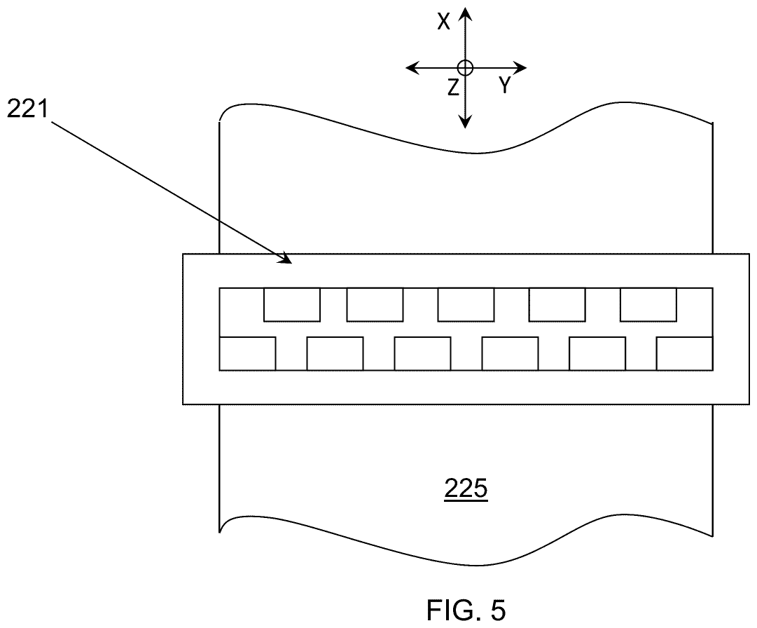

In embodiments, the board bond measuring system 220 comprises an evaluation system following principles of the present disclosure that includes a controller programmed with a mat-faced cementitious board analyzing application as described above and in operable communication with the arrays 221, 222. The arrays 221, 222 are configured to span across the width of the board 225, measured in the transverse Y-axis, which is perpendicular to the machine direction 210 along which the conveyor sections 211, 212 transport the mat-faced cementitious board 225 (see FIG. 5).

The board bond measuring system 220 includes the non-contact ultrasound transmitter transducer array 221, the non-contact ultrasound receiver transducer array 222, a controller 230, a non-transitory computer-readable medium 271, a data storage device 273, and a display device 272. The non-contact ultrasound transmitter transducer array 221 and the non-contact ultrasound receiver transducer array 222 are disposed in the unsupported span between the conveyor sections 211, 212 such that the transducer arrays 221, 222 extend along the transverse Y-axis. In embodiments, the controller 230 is programmed to control the transducer arrays 221, 222 and to receive signals therefrom indicative of the ultrasound signal emitted by the transmitter transducer array 221 and the received ultrasound signal received by the receiver transducer array 222 from the transmitter transducer array 221 after passing through the mat-faced cementitious board 225. The non-transitory computer-readable medium 271 bears a board bond measurement program. The controller 230 is configured to execute the board bond measurement program contained on the non-transitory computer-readable medium 271 to determine a value of the board bond strength. The data storage device 273 is in operable communication with the controller 230 and is configured to store board bond data generated by the controller 230.

The transducer arrays 221, 222 are disposed in spaced relationship to each other along a normal Z-axis, which is perpendicular to both the machine direction 210 and the transverse Y-axis, such that the mat-faced cementitious board 225 is adapted to move along the machine direction 210 from the upstream support surface 211 to the downstream support surface 212 and pass between the transducer arrays 221, 222 along the normal X-axis.

The ultrasound transmitter transducer array 221 is configured to emit an ultrasound signal therefrom along the normal Z-axis such that the ultrasound signal passes through the mat-faced cementitious board 225 and is received by the ultrasound receiver transducer array 222. The ultrasound receiver transducer array 222 is configured to transmit an ultrasound reception signal therefrom to the controller 230. The ultrasound reception signal is indicative of the strength of the ultrasound signal received by the ultrasound receiver transducer array 222 from the ultrasound transmitter transducer array 221.

In embodiments, the ultrasound receiver transducer array 222 is configured to transmit the ultrasound reception signal to the controller 30 substantially continuously. In embodiments, the ultrasound transmitter transducer array 221 is configured to emit an ultrasound signal continuously, which includes emitting a pulse signal of a given period at a regular frequency.

In embodiments, the evaluation system 220 can include any suitable ultrasonic transducer array. For example, in embodiments, the evaluation system 220 can include any suitable non-contact (air coupled) ultrasonic transducer array so that the board bond measuring system 220 can be used to evaluate bond strength in a manner that is free from any contact with the mat-faced cementitious board 225 as it moves along the machine direction 210 is shown in FIG. 4. In embodiments, the non-contact ultrasonic transducers arrays 221, 222 can includes transducers be similar to those described in U.S. Pat. No. 6,311,573, entitled “Ultrasonic Transducer for High Transduction in Gases and Method for Non-contact Transmission in Solids,” incorporated herein by reference in its entirety.

The controller 230 is in operable arrangement with the ultrasound receiver transducer array 222 to receive the ultrasound reception signal therefrom. The controller 230 is in operable arrangement with the non-transitory computer-readable medium 271 such that the controller 230 is configured to execute the board bond measurement program contained on the non-transitory computer-readable medium 271.

In embodiments, the controller 230 is in communication with the ultrasound transmitter transducer array 221 to receive an ultrasound transmission signal therefrom. The ultrasound transmission signal is indicative of the strength of an ultrasound signal emitted by the ultrasound transmitter transducer array 221 for interaction with the mat-faced cementitious board 225. In embodiments, the controller 230 is programmed to determine the numerical bond strength value for the mat-faced cementitious board 225 based upon the ultrasound transmission signal and the ultrasound reception signal received respectively from the transmitter transducer array 221 and the receiver transducer array 222.

In embodiments, the controller 230 is programmed to operate the transmitter transducer array 221 and the receiver transducer array 222. In embodiments, the controller 230 includes a transmitter transducer excitation mechanism in operable arrangement with the ultrasound transmitter transducer array 221 and a receiving transducer amplification mechanism in operable arrangement with the ultrasound receiver transducer array 222 to facilitate the operable control of the arrays 221, 222 via the controller 230. In embodiments, the controller 230 includes an analog-to-digital converter for processing at least one of the ultrasound transmission signal and the ultrasound reception signal use by the logic unit of the controller 230 executing the board bond measurement program.

In embodiments, the board bond measurement program includes a control module, a bond strength module, and a communication module. The control module is configured to control the operation of the ultrasound transmitter transducer array 221 and the ultrasound receiver transducer array 222.

The bond strength module is configured to determine a numerical bond strength value for the mat-faced cementitious board 225 based upon the ultrasound reception signal from the ultrasound receiver transducer array 222. In embodiments, the bond strength module of the board bond measurement program is configured to determine the numerical bond strength value for the mat-faced cementitious board based upon the ultrasound reception signal and the ultrasound transmission signal. In at least some of such embodiments, the bond strength module of the board bond measurement program is configured to determine the numerical bond strength value for the mat-faced cementitious board 225 by determining the difference between the ultrasound transmission signal and the ultrasound reception signal to determine a signal strength attenuation value.

In embodiments, the bond strength module of the board bond measurement program is configured to determine the numerical bond strength value for the mat-faced cementitious board by calculating an average signal strength attenuation value over a length of the ultrasound receiver transducer array along the cross-machine direction. In embodiments, the bond strength module of the board bond measurement program is configured to determine a numerical bond strength value for each of the mats bonded to the core of the mat-faced cementitious board.

In embodiments, the bond strength module of the board bond measurement program is configured to determine the numerical bond strength value for the mat-faced cementitious board using mat-faced cementitious board bond data stored in a database of the data storage device 273. For example, in embodiments, the data storage device 273 includes a database of mat-faced cementitious board specimen data which includes attenuated signal strength data and destructive Z-bond pull data for each such specimen. In embodiments, the measured numerical bond strength value for a mat-faced cementitious board 225 can be compared to the database to extrapolate a Z-bond pull value for the board 225 without conducting such destructive testing.

The communication module is configured to transmit a bond data stream to the display device 272. In embodiments, the bond data stream includes the numerical bond strength data determined by the bond strength module. In embodiments, the communication module of the board bond measurement is configured to transmit an alert signal to the display device 272 when the numerical bond strength value determined by the bond strength module is below a predetermined value. The display device 272 can issue any suitable visual and/or auditory indicia configured to convey to an operator that the numerical bond strength value determined by the bond strength module is below the predetermined value.

The data storage device 273 includes a database configured to store mat-faced cementitious board bond data generated by the board bond measurement program. In embodiments, the data storage device 273 includes a database configured to store mat-faced cementitious board bond data for use by the board bond measurement program. In embodiments, the mat-faced cementitious board bond data comprises destructive Z-bond separation pull test data for a number of specimens and correlated signal strength attenuation value data for the number of specimens. The bond strength module of the board bond measurement program can be configured to query the database to estimate a value for a destructive Z-bond separation pull force for the mat-faced cementitious board 225 by comparing the signal strength attenuation value determined by the bond strength module to the database of correlated signal strength attenuation value data.

The display device 272 is in operable arrangement with the controller 230. In embodiments, the display device 272 can comprise any suitable display device and include a suitable graphical user interface for interacting with the board bond measurement program.

In embodiments, the system 200 for manufacturing a cementitious board 225 can include other components and stations, as one skilled in the art will appreciate. For example, in embodiments, the system 200 can include a wet end system, a forming station, a cutting station, a transfer system-including a board inverter, the kiln, the transducer arrays 221, 222, and a bundler and taping station.

In embodiments of a method of manufacturing a mat-faced cementitious board following principles of the present disclosure, a system for measuring board bond strength according to principles of the present disclosure is used to determine the degree to which at least one mat is bonded to the cementitious core within the cementitious board in an on-line manner during the continuous manufacture of the mat-faced cementitious board. In embodiments, a method of manufacturing a mat-faced cementitious board following principles of the present disclosure can be used with any embodiment of a system for manufacturing a mat-faced cementitious board according to principles discussed herein.

In one embodiment, a method of manufacturing a mat-faced cementitious board includes applying a mat to a cementitious core, which is formed from an aqueous cementitious slurry. The mat-faced cementitious board is dried in a kiln to remove excess water from the aqueous cementitious slurry. The mat-faced cementitious board is conveyed along a machine direction away from the kiln. The mat-faced cementitious board extends along the machine direction and along a transverse axis, which is perpendicular to the machine direction.

The mat-faced cementitious board is passed along the machine direction past a non-contact ultrasound transmitter transducer array and a non-contact ultrasound receiver transducer array. The transducer arrays extend along the transverse axis and are in spaced relationship to each other along a normal axis, which is perpendicular to the machine direction and to the transverse axis, such that the mat-faced cementitious board passes between the transducer arrays along the normal axis. In embodiments, passing the mat-faced cementitious board along the machine direction between the non-contact ultrasound transmitter transducer array and the non-contact ultrasound receiver transducer array comprises positioning the transducer arrays along the normal axis such that the transducer arrays are in non-contacting relationship with the mat-faced cementitious board.

An ultrasound signal is emitted from the ultrasound transmitter transducer array such that the ultrasound signal passes through the mat-faced cementitious board and is received by the ultrasound receiver transducer array. The ultrasound receiver transducer array transmits an ultrasound reception signal to a controller. The ultrasound reception signal is indicative of the strength of the ultrasound signal received by the ultrasound receiver transducer from the ultrasound transmitter transducer. In embodiments, the ultrasound signal is emitted from the ultrasound transmitter transducer array and the ultrasound reception signal is transmitted from the ultrasound receiver transducer array to the controller substantially continuously.

A board bond measurement program stored upon a non-transitory computer-readable medium is executed using the controller to generate, based upon the ultrasound reception signal, a numerical bond strength value for the mat-faced cementitious board. In embodiments, executing the board bond measurement program stored upon the non-transitory computer-readable medium using the controller includes transmitting an alert signal to a display device when the numerical bond strength value generated for the mat-faced cementitious board is below a predetermined value. In embodiments, executing the board bond measurement program stored upon the non-transitory computer-readable medium using the controller includes displaying, through a graphical user interface, the numerical bond strength value for the mat-faced cementitious board in a display device.

In embodiments, the method further includes periodically cutting a mat-faced cementitious board precursor to define a series of mat-faced cementitious boards as the mat-faced cementitious board precursor moves along the machine direction past a cutting station. The cutting station is disposed upstream of the non-contact ultrasound transmitter transducer array and the non-contact ultrasound receiver transducer array along the machine direction. In embodiments, the method further includes passing each of the series of mat-faced cementitious boards along the machine direction between the non-contact ultrasound transmitter transducer array and the non-contact ultrasound receiver transducer array so that the controller generates a numerical bond strength value for each of the series of mat-faced cementitious boards.

All references cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for manufacturing a mat-faced cementitious board, the mat-faced cementitious board having a mat bonded to a cementitious core, the cementitious core formed from an aqueous cementitious slurry, the system comprising:
a kiln, the kiln configured to remove excess water from the aqueous cementitious slurry;
a conveyor, the conveyor configured to convey the cementitious board along a machine direction away from the kiln, the conveyor including an upstream support surface and a downstream support surface, the upstream support surface and the downstream support surface both extending along the machine direction and a transverse axis, the transverse axis being perpendicular to the machine direction, the upstream support surface and the downstream support surface in discontinuous relationship with respect to each other such that an unsupported span is defined therebetween;
a board bond measuring system, the board bond measuring system including:
a non-contact ultrasound transmitter transducer array and a non-contact ultrasound receiver transducer array disposed in the unsupported span such that the transducer arrays extend along the transverse axis, the transducer arrays being disposed in spaced relationship to each other along a normal axis, the normal axis being perpendicular to both the machine direction and the transverse axis, such that the mat-faced cementitious board is adapted to move along the machine direction from the upstream support surface to the downstream support surface and pass between the transducer arrays along the normal axis, the ultrasound receiver transducer array configured to transmit an ultrasound reception signal therefrom, the ultrasound reception signal indicative of the strength of an ultrasound signal received by the ultrasound receiver transducer array from the ultrasound transmitter transducer array,
a non-transitory computer-readable medium, the non-transitory computer-readable medium bearing a board bond measurement program, and
a controller, the controller in operable arrangement with the ultrasound receiver transducer array to receive the ultrasound reception signal therefrom, the controller in operable arrangement with the non-transitory computer-readable medium such that the controller is configured to execute the board bond measurement program contained thereon,
wherein the board bond measurement program includes a bond strength module configured to determine a numerical bond strength value for the mat-faced cementitious board based upon the ultrasound reception signal.

2. The system for manufacturing according to claim 1, further comprising:
a display device, the display device in operable arrangement with the controller;
wherein the board bond measurement program includes a communication module, the communication module configured to transmit a bond data stream to the display device, the bond data stream including the numerical bond strength value determined by the bond strength module.

3. The system for manufacturing according to claim 2, wherein the communication module of the board bond measurement is configured to transmit an alert signal to the display device when the numerical bond strength value determined by the bond strength module is below a predetermined value.

4. The system for manufacturing according to claim 1, wherein the ultrasound receiver transducer array is configured to transmit the ultrasound reception signal to the controller substantially continuously.

5. The system for manufacturing according to claim 1, wherein the controller is in communication with the ultrasound transmitter transducer array to receive an ultrasound transmission signal therefrom, the ultrasound transmission signal indicative of the strength of an ultrasound signal transmitted by the ultrasound transmitter transducer array, and wherein the bond strength module of the board bond measurement program is configured to determine the numerical bond strength value for the mat-faced cementitious board based upon the ultrasound reception signal and the ultrasound transmission signal.

6. The system for manufacturing according to claim 5, wherein the bond strength module of the board bond measurement program is configured to determine the numerical bond strength value for the mat-faced cementitious board by determining the difference between the ultrasound transmission signal and the ultrasound reception signal to determine a signal strength attenuation value.

7. The system for manufacturing according to claim 6, wherein the bond strength module of the board bond measurement program is configured to determine the numerical bond strength value for the mat-faced cementitious board by calculating an average signal strength attenuation value over a length of the ultrasound receiver transducer array along the transverse axis.

8. The system for manufacturing according to claim 6, further comprising:
a data storage device, the data storage device in operable communication with the controller, the data storage device including a database configured to store mat-faced cementitious board bond data for use by the board bond measurement program;
wherein the bond strength module of the board bond measurement program is configured to determine the numerical bond strength value for the mat-faced cementitious board using the mat-faced cementitious board bond data stored in the database of the data storage device.

9. The system for manufacturing according to claim 8, wherein the mat-faced cementitious board bond data comprises destructive Z-bond separation pull test data for a number of specimens and correlated signal strength attenuation value data for the number of specimens, and wherein the bond strength module of the board bond measurement program is configured to query the database to estimate a value for a destructive Z-bond separation pull force for the mat-faced cementitious board by comparing the signal strength attenuation value determined by the bond strength module to the database of correlated signal strength attenuation value data.

10. The system for manufacturing according to claim 1, wherein the mat-faced cementitious board includes a pair of mats bonded to the cementitious core such that the cementitious core is interposed between the pair of mats, and wherein the bond strength module of the board bond measurement program is configured to determine a numerical bond strength value for each of the mats bonded to the core of the mat-faced cementitious board.

11. The system for manufacturing according to claim 1, wherein the board bond measurement program includes a control module configured to control the operation of the ultrasound transmitter transducer array and the ultrasound receiver transducer array.

12. The system for manufacturing according to claim 11, wherein the controller includes a transmitter transducer excitation mechanism in operable arrangement with the ultrasound transmitter transducer array and a receiving transducer amplification mechanism in operable arrangement with the ultrasound receiver transducer array.

13. The system for manufacturing according to claim 1, wherein the controller includes an analog-to-digital converter, the ultrasound reception signal being directed through the analog-to-digital converter.

14. The system for manufacturing according to claim 1, further comprising:
a cutting station, the cutting station disposed upstream of the kiln along the machine direction, the cutting station including a knife configured to periodically cut the cementitious board along the transverse axis to define a series of board segments as the cementitious board moves along the machine direction past the cutting station.

15. A method of manufacturing a mat-faced cementitious board, the method comprising:
applying a mat to a cementitious core, the cementitious core formed from an aqueous cementitious slurry;
drying the mat-faced cementitious board in a kiln to remove excess water from the aqueous cementitious slurry;
conveying the mat-faced cementitious board along a machine direction away from the kiln, the mat-faced cementitious board extending along the machine direction and along a transverse axis, the transverse axis perpendicular to the machine direction;
passing the mat-faced cementitious board along the machine direction past a non-contact ultrasound transmitter transducer array and a non-contact ultrasound receiver transducer array, the transducer arrays extending along the transverse axis and in spaced relationship to each other along a normal axis, the normal axis being perpendicular to the machine direction and to the transverse axis, such that the mat-faced cementitious board passes between the transducer arrays along the normal axis;
emitting an ultrasound signal from the ultrasound transmitter transducer array such that the ultrasound signal passes through the mat-faced cementitious board and is received by the ultrasound receiver transducer array;
transmitting to a controller an ultrasound reception signal from the ultrasound receiver transducer array, the ultrasound reception signal indicative of the strength of the ultrasound signal received by the ultrasound receiver transducer array from the ultrasound transmitter transducer array;
executing a board bond measurement program stored upon a non-transitory computer-readable medium using the controller to generate a numerical bond strength value for the mat-faced cementitious board based upon the ultrasound reception signal.

16. The method of manufacturing according to claim 15, wherein passing the mat-faced cementitious board along the machine direction between the non-contact ultrasound transmitter transducer array and the non-contact ultrasound receiver transducer array comprises positioning the transducer arrays along the normal axis such that the transducer arrays are in non-contacting relationship with the mat-faced cementitious board.

17. The method of manufacturing according to claim 16, wherein executing the board bond measurement program stored upon the non-transitory computer-readable medium using the controller includes transmitting an alert signal to a display device when the numerical bond strength value generated for the mat-faced cementitious board is below a predetermined value.

18. The method of manufacturing according to claim 16, further comprising:
periodically cutting a mat-faced cementitious board precursor to define a series of mat-faced cementitious boards as the mat-faced cementitious board precursor moves along the machine direction past a cutting station, the cutting station disposed upstream of the non-contact ultrasound transmitter transducer array and the non-contact ultrasound receiver transducer array along the machine direction;
passing each of the series of mat-faced cementitious boards along the machine direction between the non-contact ultrasound transmitter transducer array and the non-contact ultrasound receiver transducer array.

19. The method of manufacturing according to claim 18, wherein the ultrasound signal is emitted from the ultrasound transmitter transducer array and the ultrasound reception signal is transmitted from the ultrasound receiver transducer array to the controller substantially continuously.

20. The method of manufacturing according to claim 19, wherein executing the board bond measurement program stored upon the non-transitory computer-readable medium using the controller includes displaying, through a graphical user interface, the numerical bond strength value for the mat-faced cementitious board in a display device.
